(19) United States
(12) Patent Application Publication
(10) Pub. No.: US 2026/0245948 A1
(43) Pub. Date: Aug. 20, 2026

(54) ALL SOLID BATTERY

(71) Applicant: TAIYO YUDEN CO., LTD., Tokyo (JP)

(72) Inventors: Yusuke KAWASAKI, Tokyo (JP); Kotoko NAKASONE, Tokyo (JP); Katsunori YOKOSHIMA, Tokyo (JP)

(73) Assignee: TAIYO YUDEN CO., LTD., Tokyo (JP)

(21) Appl. No.: 19/536,366

(22) Filed: Feb. 11, 2026

(30) Foreign Application Priority Data
Feb. 18, 2025 (JP) 2025-024238

(51) Int. Cl. H01M 10/052; H01M 4/131; H01M 4/36; H01M 10/0525; H01M 10/0562

(52) U.S. Cl. CPC H01M 10/052; H01M 4/131; H01M 4/366; H01M 10/0525; H01M 10/0562

(57) ABSTRACT

An all solid battery includes a first electrode layer including a first electrode layer including a first electrode that includes a first electrode active material and is quadrilateral, and a first margin that is quadrilateral, the first electrode layer being formed by connecting the first electrode and the first margin, a second electrode layer including a second electrode that has a quadrilateral shape in plan view and that includes a second electrode active material that has a lower average operating potential than the first electrode active material, and a second margin that is connected to one side of the quadrilateral shape of the second electrode, the quadrilateral shape having a first side and a second side that are adjacent to the one side, the second margin extending to the first side, and a solid electrolyte layer arranged between the first electrode layer and the second electrode layer.

### CROSS-REFERENCE TO RELATED APPLICATION

This application is based upon and claims the benefit of priority of the prior Japanese Patent Application No. 2025-024238, filed on Feb. 18, 2025, the entire contents of which are incorporated herein by reference.

### FIELD

A certain aspect of the present invention relates to an all solid battery.

### BACKGROUND

In recent years, secondary batteries have been used in a variety of fields. Secondary batteries that use liquid electrolytes have issues such as electrolyte leakage. As a result, development is underway for all-solid-state batteries that include a solid electrolyte and other solid components.

In order to achieve higher energy density in this field of all-solid-state batteries, a stacked-type all solid battery has been proposed, which includes two or more battery units (also known as single cells) each consisting of a positive electrode, a solid electrolyte layer, and a negative electrode (See, for example, Japanese Patent Application Publication No. 2007-80812 (hereinafter referred to as Document 1), Japanese Patent Application Publication No. 2014-192041 (hereinafter referred to as Document 2), International Publication No. 2020/179934 (hereinafter referred to as Document 3), and Japanese Patent Application Publication No. 2015-125893 (hereinafter referred to as Document 4)).

### SUMMARY OF THE INVENTION

According to an aspect of the present invention, there is provided an all solid battery including: a first electrode layer including a first electrode that includes a first electrode active material and that is quadrilateral in plan view, and a first margin that is quadrilateral in plan view, the first electrode layer being formed by connecting the first electrode and the first margin; a second electrode layer including a second electrode that has a quadrilateral shape in plan view and that includes a second electrode active material that has a lower average operating potential than the first electrode active material, and a second margin that is connected to one side of the quadrilateral shape of the second electrode, the quadrilateral shape having a first side and a second side that are adjacent to the one side, the second margin extending to the first side; and a solid electrolyte layer arranged between the first electrode layer and the second electrode layer.

According to an aspect of the present invention, there is provided an all solid battery including: a first electrode layer including a first electrode that includes a first electrode active material and that is quadrilateral in plan view, and a first margin that is quadrilateral in plan view, the first electrode layer being formed by connecting the first electrode and the first margin, the first electrode active material capable of absorbing and releasing lithium ions, the first electrode active material being an oxide containing lithium and including at least one element selected from a group consisting of titanium, vanadium, manganese, iron, cobalt, nickel, phosphorus, and silicon; a second electrode layer including a second electrode that has a quadrilateral shape in plan view and that includes a second electrode active material that has a lower average operating potential than the first electrode active material, and a second margin that is connected to one side of the quadrilateral shape of the second electrode, the quadrilateral shape having a first side and a second side that are adjacent to the one side, the second margin extending to the first side, a second electrode active material capable of absorbing and releasing lithium ions, the second electrode active material being any one of an oxide, a conductive carbon material, an elemental metal, or an alloy containing at least one element selected from a group consisting of lithium, titanium, niobium, tantalum, and hafnium; and a solid electrolyte layer arranged between the first electrode layer and the second electrode layer.

### BRIEF DESCRIPTION OF THE DRAWINGS

FIG. 1A illustrates a schematic cross section of a basic structure of an all solid battery;

FIG. 1B illustrates a positive electrode, a negative electrode and a solid electrolyte layer;

FIG. 2 illustrates a perspective view of a multilayer chip in which multiple battery units are stacked;

FIG. 3 illustrates a cross-sectional view taken along line A-A in FIG. 2;

FIG. 4 illustrates a cross-sectional view taken along line B-B in FIG. 2;

FIG. 5A illustrates an enlarged cross-section of a first end margin;

FIG. 5B illustrates an enlarged cross-sectional view of a second end margin;

FIG. 6A illustrates an enlarged cross-sectional view of a first side margin;

FIG. 6B illustrates an enlarged cross-sectional view of a second side margin;

FIG. 7 illustrates a perspective view of a stacked-type all solid battery;

FIG. 8 illustrates a multilayer structure;

FIG. 9 illustrates a flowchart of a manufacturing method of an all solid battery;

FIG. 10 illustrates a stacking process;

FIG. 11 illustrates a cutting process;

FIG. 12 illustrates Comparative Example 1;

FIG. 13 illustrates Comparative Example 2; and

FIG. 14 illustrates Comparative Example 3.

### DETAILED DESCRIPTION

Document 1 discloses an internal electrode structure for an all solid battery with a stacked structure similar to that of a multilayer ceramic capacitor. When positive and negative electrode sections are stacked with a solid electrolyte layer sandwiched therebetween, a gap occurs in the total thickness between the electrode intersections and non-intersections of the positive and negative electrode sections, resulting in distortion. Because such distortion may lead to cracks and short circuits, providing a margin around the electrode section, as in Document 2, is effective. According to Document 2, the margin section, when viewed from above, has a laterally U-shape that surrounds three sides of the rectangular electrode section.

If there is a mismatch in the shrinkage behavior of the electrode section and the margin section during heat treatment, problems such as cracking may occur during the sintering process. Various simulations have shown that a laterally U-shaped margin section formed around the outer periphery of the electrode section, as in Document 2, may cause internal stress during sintering if there is even a slight mismatch in thermal shrinkage with the electrode section. Therefore, a structure that can reduce internal stress is desirable.

In view of this, it is believed that by exposing the internal electrodes on the side surfaces of a stacked battery, as described in Document 3, the boundary between the internal electrodes and the margin portion can be reduced, thereby reducing internal stress. However, this increases the amount of moisture in the air that adheres to the internal electrodes during the manufacturing process, resulting in a high rate of defective drying during the drying process used to remove the adhered moisture. Poor drying results in a problem of reduced battery charge/discharge coulombic efficiency. This occurs because moisture adhered to the internal electrodes is reduced and decomposed due to the low potential of the electrode active material after charging.

A description will be given of an embodiment with reference to the accompanying drawings.

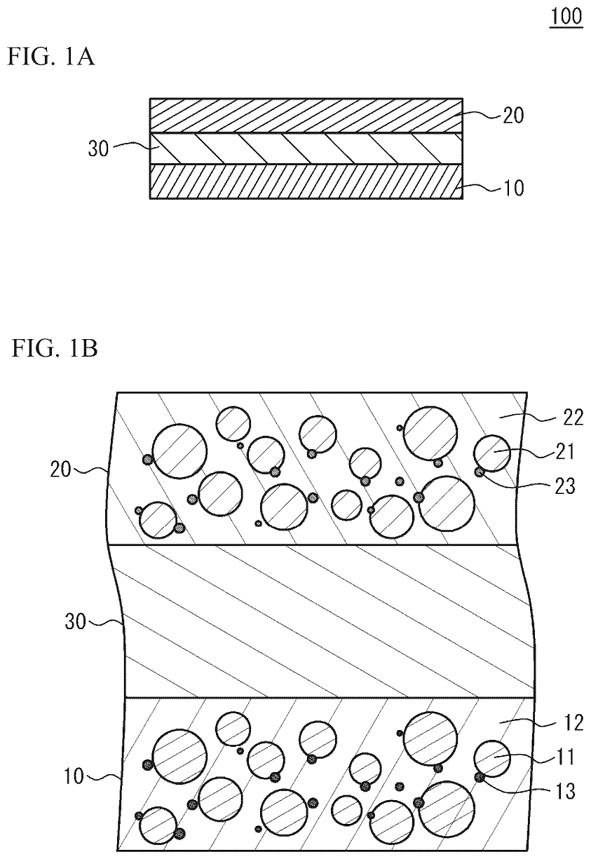

(Embodiment) FIG. 1A illustrates a schematic cross section of a basic structure of an all solid battery 100. As illustrated in FIG. 1A, the all solid battery 100 has a structure in which a positive electrode 10 (a first internal electrode) and a negative electrode 20 (a second internal electrode) sandwich a solid electrolyte layer 30. The positive electrode 10 is provided on a first main face of the solid electrolyte layer 30. The negative electrode 20 is provided on a second main face of the solid electrolyte layer 30. For example, the positive electrode 10, the negative electrode 20 and the solid electrolyte layer 30 have a sintered body which is formed by sintering powder materials.

A main component of the solid electrolyte layer 30 is a solid electrolyte having ionic conductivity. The solid electrolyte of the solid electrolyte layer 30 is an oxide-based solid electrolyte having lithium ion conductivity. The solid electrolyte is, for example, phosphate-based electrolyte having a NASICON crystal structure. For example, the solid electrolyte of the solid electrolyte layer 30 is oxide-based solid electrolyte having lithium ion conductivity. The phosphate is not limited. For example, the phosphate is such as composite salt of phosphate with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphate is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like.

As illustrated in FIG. 1B, the positive electrode 10 has a structure in which a positive electrode active material 11 (first electrode active material), a solid electrolyte 12, a conductive aid 13 and the like are dispersed. The negative electrode 20 has a structure in which a negative electrodes active material 21 (second electrode active material), a solid electrolyte 22, a conductive aid 23 and the like are dispersed. The positive electrode 10 includes the positive electrode active material 11 and the negative electrode 20 includes the negative electrodes active material 21, allowing the all solid battery 100 to be used as a secondary battery. The positive electrode 10 includes the solid electrolyte 12 and the negative electrode 20 includes the solid electrolyte 22, thereby achieving ion conductivity in the positive electrode 10 and the negative electrode 20. The positive electrode 10 includes the conductive aid 13 and the negative electrode 20 includes the conductive aid 23, thereby achieving electrical conductivity for the positive electrode 10 and the negative electrode 20. The solid electrolytes 12 and 22 may be, for example, the same solid electrolyte as the solid electrolyte layer 30, or may be different solid electrolytes.

The positive electrode active material 11 is an electrode active material that functions as a positive electrode. The average operating potential of the positive electrode active material 11 is not particularly limited, but in this embodiment, it is, for example, 3 V vs. Li/Li⁺ or higher.

Here, the average operating potential refers to the average discharge potential of the electrode active material when a battery is discharged from a fully charged state to the end-of-discharge voltage under standard conditions. The discharge potential is based on the oxidation-reduction potential of a metallic lithium electrode. The average operating potential can be measured by charging and discharging a battery that combines an electrode containing an electrode active material with an unknown operating potential and an electrode with a known operating potential as the counter electrode.

The positive electrode active material 11 is, for example, a lithium-containing oxide electrode active material that can absorb and release lithium ions and contains at least one element from the group consisting of titanium, vanadium, manganese, iron, cobalt, nickel, phosphorus, and silicon.

The positive electrode active material 11 is, for example, an electrode active material having an olivine-type crystal structure. The positive electrode active material is such as a phosphate containing a transition metal and lithium. The olivine-type crystal structure is a crystal of a natural olivine, and can be determined by X-ray diffraction.

A typical example of a positive electrode active material with an olivine crystal structure is LiCoPO₄, which contains Co. Phosphates in which the Co in this chemical formula is replaced by a transition metal can also be used. The ratio of Li and PO₄ can vary depending on the valence. It is preferable to use Co, Mn, Fe, Ni or the like as the transition metal. For example, LiFePO₄, LiMnPO₄, Li_{1-y}Co_{1-x+y}NiₓP_{1-y}Si_{y}O₄ (0<x≤1, 0≤y<0.1) or the like can be used.

Alternatively, the positive electrode active material 11 can be a layered rock salt active material such as LiCoO₂ or LiCo_{1-x-y}NiₓMn_{y}O₂ (0<x+y≤1), or a spinel active material such as LiMn₂O₄ or LiNi_{0.5}Mn_{1.5}O₄.

The negative electrodes active material 21 uses an electrode active material that functions as a negative electrodes electrode. The average operating potential of the negative electrodes active material 21 is not particularly limited, but is lower than the average operating potential of the positive electrode active material 11. For example, the average operating potential of the negative electrodes active material 21 is 2.4 V vs. Li/Li⁺ or less. From the perspective of increasing the battery voltage and energy density of the all solid battery 100, the average operating potential of the negative electrodes active material 21 is preferably less than 2 V vs. Li/Li⁺. For example, an electrode active material capable of absorbing and releasing lithium ions, which is any of an oxide, a conductive carbon material, a simple metal, and an alloy containing at least one element selected from the group consisting of lithium, titanium, niobium, tantalum, and hafnium, can be used as the negative electrodes active material 21. For example, TiO₂, Li₄Ti₅O₁₂, a Li—Al—Co—Ti—P—O-based compound, a Ti—Ta—Nb—O-based compound, an Al—Nb—Hf—Ta—O-based compound, graphite, hard carbon or the like can be used as the negative electrode active material 21.

Carbon materials or the like are used as the conductive aids 13 and 23. Metals may be used as the conductive aids 13 and 23. An example of the conductive aid metal is such as Pd, Ni, Cu, Fe, or an alloy containing two or more of these.

In this embodiment, the average operating potential of the negative electrodes active material 21 is lower than the average operating potential of the positive electrode active material 11, causing the positive electrode 10 to function as a positive electrode and the negative electrode 20 to function as a negative electrode. However, at least one of the positive electrode active material 11 and the negative electrodes active material 21 may contain multiple types of electrode active materials. In this case, the overall average operating potential of the negative electrode 20 is lower than the overall average operating potential of the positive electrode 10.

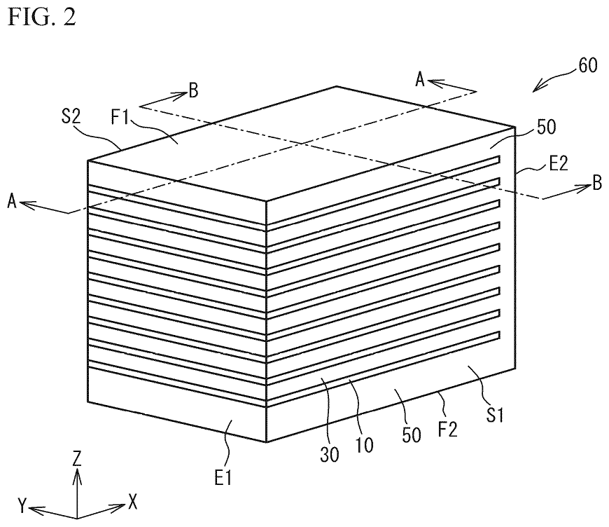

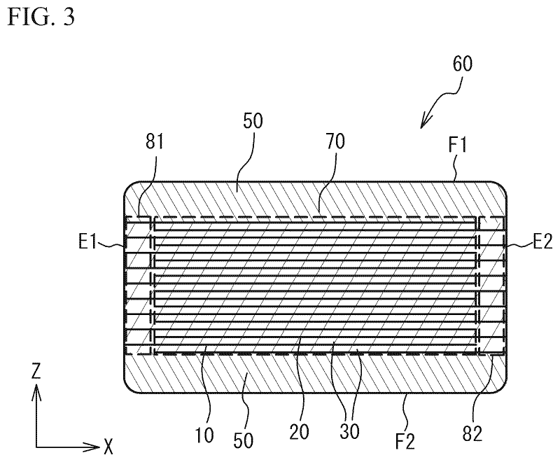

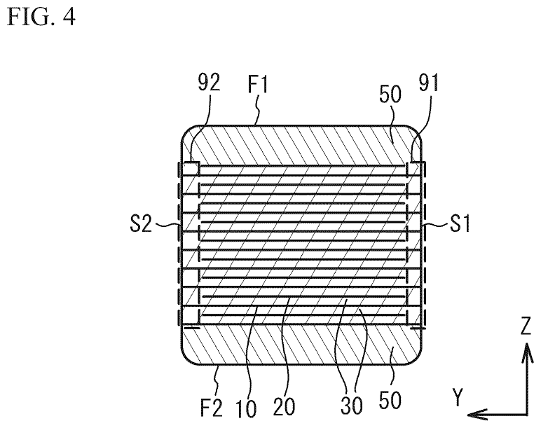

FIG. 2 is a perspective view of a multilayer chip 60 in which multiple battery units are stacked. FIG. 3 is a cross-sectional view taken along line A-A in FIG. 2. FIG. 4 is a cross-sectional view taken along line B-B in FIG. 2. The multilayer chip 60 has a roughly rectangular parallelepiped shape. The multilayer chip 60 has an upper surface F1 and a lower surface F2 at the ends of each layer in the stacking direction, a first end surface E1 and a second end surface E2 that face each other, and a first side surface S1 and a second side surface S2 that face each other.

Note that in FIG. 2 to FIG. 4, the Z-axis direction (first direction) is the stacking direction, and is the direction in which the upper surface F1 and the lower surface F2 of the multilayer chip 60 face each other. The X-axis direction (second direction) is the direction in which the first end surface E1 and the second end surface E2 of the multilayer chip 60 face each other. The Y-axis direction (third direction) is the direction in which the first side surface S1 and the second side surface S2 face each other. The X-axis direction, Y-axis direction, and Z-axis direction are mutually orthogonal.

In the following description, components having the same composition range as the all solid battery 100 are designated by the same reference numerals, and detailed description thereof will be omitted.

In the multilayer chip 60, the positive electrodes 10 and the negative electrodes 20 are alternately stacked with each of the solid electrolyte layers 30 interposed therebetween. The X-axis edge of the positive electrodes 10 extends to the first end surface E1 of the multilayer chip 60 but does not extend to the second end surface E2. The X-axis edge of the negative electrodes 20 extends to the second end surface E2 of the multilayer chip 60 but does not extend to the first end surface E1. The solid electrolyte layer 30 extends from the first end surface E1 to the second end surface E2. In this manner, the multilayer chip 60 has a structure in which multiple battery units are stacked. Here, the case where they are alternately stacked will be described, but in some portions, the positive electrode 10, the negative electrode 20 and the solid electrolyte layer 30 may be stacked continuously as appropriate.

A cover layer 50 is stacked on the upper end surface of the multilayer portion of the positive electrode 10, the solid electrolyte layer 30, and the negative electrode 20. The cover layer 50 contacts the uppermost electrode section (either the positive electrode 10 or the negative electrode 20) and also contacts a portion of the solid electrolyte layer 30. Another cover layer 50 is also stacked on the lower end surface of the multilayer portion. The cover layer 50 contacts the lowermost electrode section (either the positive electrode 10 or the negative electrode 20) and also contacts a portion of the solid electrolyte layer 30. For example, the cover layer 50 is a sintered body obtained by sintering a powder material.

As illustrated in FIG. 3, the section where the positive electrode 10 and the negative electrode 20 face each other is a section that generates battery capacity. Therefore, this section is referred to as a battery capacity section 70. In other words, the battery capacity section 70 is a section where two adjacent electrode portions drawn to different end surfaces face each other.

The section near the first end surface E1 where the positive electrodes 10 face each other without the negative electrode 20 interposed therebetween is referred to as a first end margin 81. Furthermore, the section near the second end surface E2 where the negative electrodes 20 face each other without the positive electrode 10 interposed therebetween is referred to as a second end margin 82. In other words, the end margin is a section where electrode portions drawn to the same end surface face each other without an electrode portion drawn to a different end surface interposed therebetween. The first end margin 81 and the second end margin 82 are sections that do not generate battery capacity.

As illustrated in FIG. 4, in the multilayer chip 60, the positive electrode 10 extends to the first side surface S1 and the second side surface S2 of the multilayer chip 60. Therefore, the positive electrode 10 is extended to both the first side surface S1 and the second side surface S2 and is exposed from the first side surface S1 and the second side surface S2. On the other hand, the negative electrode 20 is not extended to either the first side surface S1 or the second side surface S2 of the multilayer chip 60. Therefore, the negative electrode 20 is not exposed from either the first side surface S1 or the second side surface S2.

In the multilayer chip 60, the section from the first side surface S1 to the battery capacity section 70 (or the section up to the negative electrode 20) is referred to as a first side margin 91. In the multilayer chip 60, the section from the second side surface S2 to the battery capacity section 70 (or the region up to the negative electrode 20) is referred to as a second side margin 92. In other words, the first side margin 91 and the second side margin 92 are sections that are provided to cover the ends of the negative electrodes 20 stacked in the multilayer body, extending toward two sides.

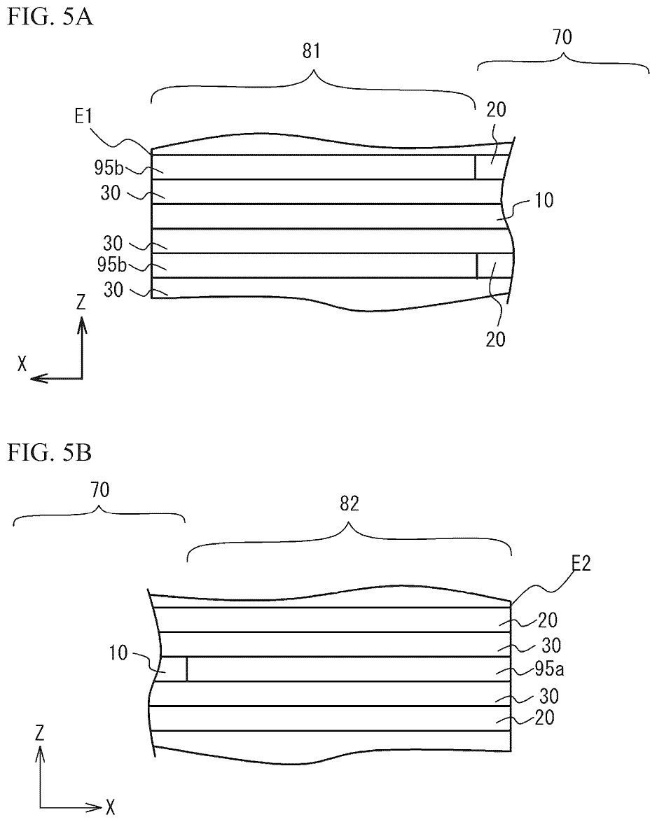

FIG. 5A is an enlarged cross-section of the first end margin 81. In the first end margin 81, the positive electrode 10 extends to the first end surface E1, but the negative electrode 20 does not extend to the first end surface E1. A negative electrode margin 95b (second margin) is provided in the same layer as the negative electrode 20. This configuration reduces the difference in level between the battery capacity section 70 and the first end margin 81.

FIG. 5B is an enlarged cross-sectional view of the second end margin 82. In the second end margin 82, the negative electrode 20 extends to the second end surface E2, while the positive electrode 10 does not extend to the second end surface E2. A positive electrode margin 95a (first margin) is provided in the same layer as the positive electrode 10. This configuration reduces the difference in level between the battery capacity section 70 and the second end margin 82.

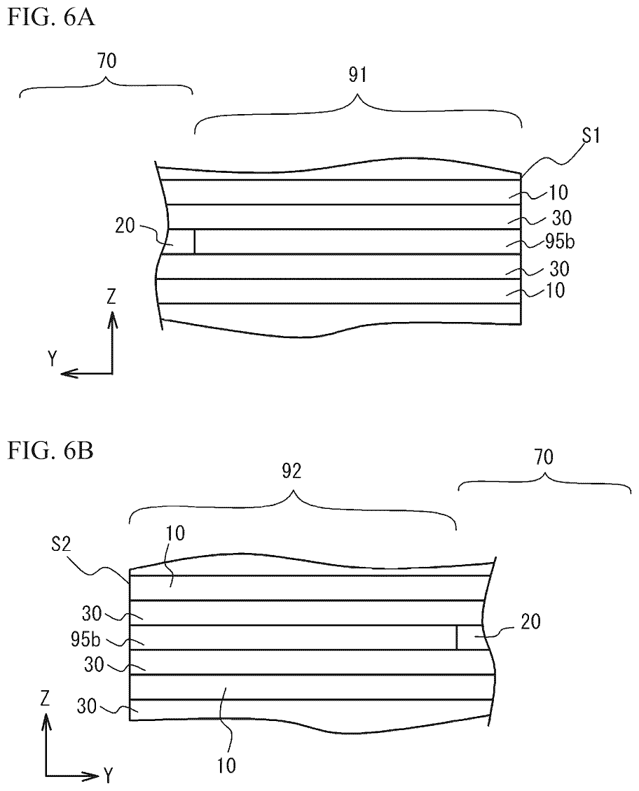

FIG. 6A is an enlarged cross-sectional view of the first side margin 91. In the first side margin 91, the positive electrode 10 extends to the first end surface E1, while the negative electrode 20 does not extend to the first end surface E1. The negative electrode margin 95b is provided in the same layer as the negative electrode 20. This configuration reduces the difference in level between the battery capacity section 70 and the first end margin 81.

FIG. 6B is an enlarged cross-sectional view of the second side margin 92. In the second side margin 92, the positive electrode 10 extends to the second end surface E2, while the negative electrode 20 does not extend to the second end surface E2. The negative electrode margin 95b is provided in the same layer as the negative electrode 20. This configuration reduces the difference in level between the battery capacity section 70 and the second end margin 82.

The positive electrode margin 95a and the negative electrode margin 95b are made of, for example, a composite of a solid electrolyte and insulating inorganic grains. The solid electrolyte used in the positive electrode margin 95a is not particularly limited, but in order to bring the sintering start temperature and sintering shrinkage rate of the positive electrode margin 95a as close as possible to those of the positive electrode 10, it is preferable that the material have the same crystal structure and the same composition formula as the solid electrolyte 12 in the positive electrode 10. Alternatively, the solid electrolyte used in the positive electrode margin 95a is preferably a material with the same crystal structure and the same composition formula as the solid electrolyte in the solid electrolyte layer 30. The solid electrolyte used in the negative electrode margin 95b is not particularly limited, but in order to bring the sintering start temperature and sintering shrinkage rate of the negative electrode margin 95b as close as possible to those of the negative electrode 20, it is preferably a material with the same crystal structure and the same composition formula as the solid electrolyte 22 in the negative electrode 20. Alternatively, the solid electrolyte used in the negative electrode margin 95b is preferably a material with the same crystal structure and composition as the solid electrolyte in the solid electrolyte layer 30. For example, the insulating inorganic grains are made of a material that does not function as an active material, such as alumina or zirconia.

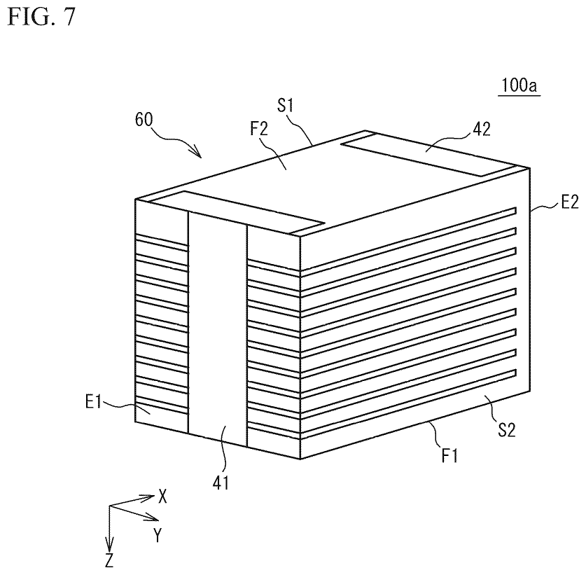

FIG. 7 is a perspective view of a stacked-type all solid battery 100a. As illustrated in FIG. 7, the all solid battery 100a has a configuration in which a first external electrode 41 (first terminal) and a second external electrode 42 (second terminal) are provided on the multilayer chip 60. Note that FIG. 7 illustrates the all solid battery 100a upside down, so the upper surface is the lower surface F2 and the lower surface is the upper surface F1.

The first external electrode 41 is provided in contact with the first end surface E1, and the second external electrode 42 is provided in contact with the second end surface E2. Therefore, the first external electrode 41 is connected to each the positive electrodes 10 and functions as a positive electrode terminal. The second external electrode 42 is connected to each of the negative electrodes 20 and functions as a negative electrodes terminal. The first external electrode 41 is connected to the positive electrodes 10 and is also in contact with the solid electrolyte layers 30 and the negative electrode margins 95b. The second external electrode 42 is connected to the negative electrodes 20 and is also in contact with the solid electrolyte layers 30 and the positive electrode margins 95a.

The first external electrode 41 may cover the entire first end surface E1 or may cover only a portion of the first end surface E1. The second external electrode 42 may cover the entire second end surface E2 or may cover only a portion of the second end surface E2. The first external electrode 41 and the second external electrode 42 extend to the lower surface F2. However, to prevent short circuits, the first external electrode 41 and the second external electrode 42 are spaced apart from each other at the lower surface F2. Furthermore, the first external electrode 41 and the second external electrode 42 are not provided on either the first side surface S1 or the second side surface S2.

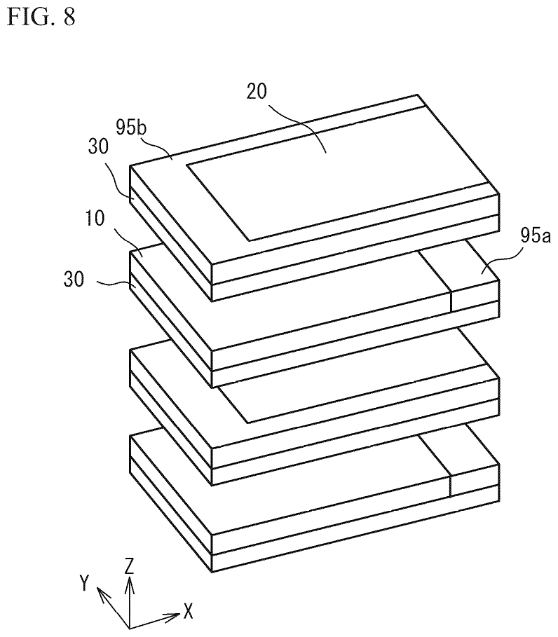

A description will be given of the all solid battery 100a according to this embodiment will now be described. As illustrated in FIG. 8, in a plan view along the Z-axis direction, the positive electrode 10 including the positive electrode active material 11 is quadrilateral, and the positive electrode margin 95a is also quadrilateral. The quadrilateral here is not particularly limited, but an example is a rectangle. However, in this case, the apex angle of the rectangle may deviate from 90° by approximately +10°, and the lengths of opposing sides may deviate by approximately +10%. Because the positive electrode 10 and the positive electrode margin 95a are disposed in the same layer, the layer formed by the positive electrode 10 and the positive electrode margin 95a is also referred to as the positive electrode layer. The positive electrode layer forms a quadrangle in plan view by connecting the positive electrode 10 and the positive electrode margin 95a at a common side (the side on the second end surface E2 side). The positive electrode 10 and the positive electrode margin 95a may be directly connected at the common side (the side on the second end surface E2 side) or may be indirectly connected via a gap or an intermediate layer.

Next, in a plan view along the Z-axis direction, the negative electrode 20 forms a quadrangle. Because the negative electrode 20 and the negative electrode margin 95b are arranged in the same layer, the layer formed by the negative electrode 20 and the negative electrode margin 95b is also referred to as the negative electrodes layer. In a plan view, the negative electrode 20 and the negative electrode margin 95b are connected by a common edge (the edge on the first end surface E1 side), and the negative electrode margin 95b extends to at least one of the edges on the first side surface S1 side and the second side surface S2 side of the negative electrode 20. In the example of FIG. 8, the negative electrode margin 95b extends to both the edge on the first side surface S1 side and the edge on the second side surface S2 side of the negative electrode 20.

With this configuration, compared to when the margins of both the positive electrode layer and the negative electrodes layer are laterally U-shaped, the interface between the margin and the positive electrode can be made smaller. This reduces the impact of thermal contraction mismatch during sintering. As a result, defects such as cracking and warping can be eliminated.

Furthermore, the negative electrode margin 95b extends to at least one of the edges on the first side surface S1 and the second side surface S2 of the negative electrode 20, which includes the negative electrodes active material 21 having a lower average operating potential than the positive electrode active material 11. In this case, adhesion of moisture to the negative electrode 20, which is prone to reductive decomposition due to the low potential of the electrode active material after charging, is suppressed, thereby suppressing deterioration of the electrical characteristics of the all solid battery 100a even if the rate of drying defects during the manufacturing process is high.

As a result, it is possible to suppress deterioration of the electrical characteristics while eliminating defects such as cracking and warping.

In order to prevent moisture from adhering to the negative electrode 20, as illustrated in FIG. 8, it is preferable that the negative electrode margin 95b extend so as to contact the entire edge of the negative electrode margin 95b on the first side surface S1 side and the entire edge of the negative electrode margin 95b on the second side surface S2 side along the X-axis direction.

The multilayer body (the multilayer chip 60) is formed by stacking the multiple positive electrode layers including the positive electrode 10 and the positive electrode margin 95a, the multiple negative electrodes layers including the negative electrode 20 and the negative electrode margin 95b, and the multiple solid electrolyte layers. In a plan view along the Z-axis direction, the overlapping four sides of the quadrilaterals of the positive electrode layer, the negative electrodes layer, and the solid electrolyte layer 30 form the outer shape of the multilayer body (the first side surface S1, the second side surface S2, the first end surface E1, and the second end surface E2). Thus, in a plan view along the Z-axis direction, the quadrilaterals of the positive electrode layer, the negative electrodes layer, and the solid electrolyte layer 30 substantially coincide.

From the viewpoint of sufficiently suppressing moisture adhesion to the negative electrode 20, the width of the negative electrode margin 95b in the Y-axis direction in a plan view along the Z-axis direction is preferably 50 μm or more, more preferably 100 μm or more, and even more preferably 300 μm or more. On the other hand, if the width of the negative electrode margin 95b is too large, the battery capacity may decrease. Therefore, in a plan view along the Z-axis direction, the width of the negative electrode margin 95b in the Y-axis direction is preferably 1000 μm or less, more preferably 800 μm or less, and even more preferably 500 μm or less.

The thickness of the solid electrolyte layer 30 is, for example, 1 μm or more and 30 μm or less, 2 μm or more and 20 μm or less, or 3 μm or more and 15 μm or less.

The thicker the positive electrode 10 and the negative electrode 20 are formed, the better the battery capacity. For example, the thickness of the positive electrode 10 and the negative electrode 20 is preferably 5 μm or more, more preferably 10 μm or more, and even more preferably 20 μm or more. Furthermore, the thickness of the positive electrode 10 and the negative electrode 20 is preferably at least 0.5 times the thickness of the solid electrolyte layer 30, more preferably at least 1 time, and even more preferably at least 1.5 times. Alternatively, the positive electrode 10 and the negative electrode 20 are preferably thicker than the solid electrolyte layer 30. Note that the thicker the positive electrode 10 and the negative electrode 20, the greater the interfacial area between the margin and the electrode when the margin is formed in a lateral U-shape, and therefore the more pronounced the effects of this embodiment.

On the other hand, if the positive electrode 10 and the negative electrode 20 are too thick, cracks may occur during heat treatment after stack formation. Even if no cracks occur, there is a risk that the battery does not respond properly during operation. Therefore, it is preferable to set an upper limit on the thickness of the positive electrode 10 and the negative electrode 20. For example, the thickness of the positive electrode 10 and the negative electrode 20 is preferably 200 μm or less, more preferably 100 μm or less, and even more preferably 80 μm or less. The thickness of the positive electrode 10 and the negative electrode 20 is preferably 200 times or less, more preferably 100 times or less, and even more preferably 80 times or less, the thickness of the solid electrolyte layer 30.

The thickness of each of the solid electrolyte layers 30 in the Z-axis direction can be measured by observing a cross section of the all solid battery 100a including the Z-axis direction with an SEM (scanning electron microscope), measuring the thickness at 10 points for each of the 10 different solid electrolyte layers 30, and deriving the average value for all the measurement points. The thickness of each of the positive electrodes 10 in the Z-axis direction can be measured by observing a cross section of the all solid battery 100a including the Z-axis direction with an SEM, measuring the thickness at 10 points for each of the 10 different positive electrodes 10, and deriving the average value for all the measurement points. The thickness of each of the negative electrodes 20 in the Z-axis direction can be measured by observing a cross section of the all solid battery 100a including the Z-axis direction with an SEM, measuring the thickness at 10 points for each of the 10 different negative electrodes 20, and deriving the average value for all the measurement points.

Furthermore, if the composition of the positive electrode 10 and the composition of the negative electrode 20 are different, the thermal contraction behavior of the positive electrode 10 and the thermal contraction behavior of the negative electrode 20 will differ, making cracks more likely to occur, and therefore the effects of this embodiment can be said to be particularly pronounced.

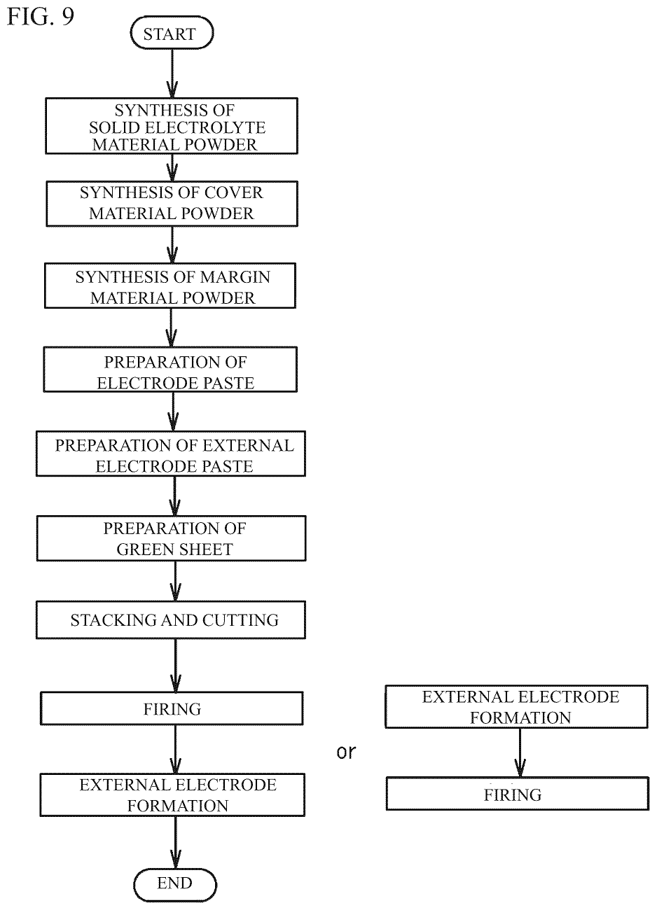

A description will be given of a manufacturing method of the all solid battery 100a. FIG. 9 illustrates a flowchart of the manufacturing method of the all solid battery 100a.

(Synthesis process of solid electrolyte material powder) A raw material powder for the solid electrolyte for the solid electrolyte layer 30 is synthesized. For example, it is possible to synthesize the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm φ.

(Synthesis process of cover material powder) A raw material powder of ceramics for the cover layer 50 is synthesized. For example, it is possible to synthesize the raw material powder for the cover layer, by mixing raw material and additives and using solid phase synthesis method or the like. By dry-pulverizing the obtained raw material powder, it is possible to adjust the obtained material powder to a desired average particle size. For example, the particles are adjusted to a desired average particle size using a planetary ball mill using ZrO₂ balls of 5 mm diameter.

(Synthesis process of margin material powder) A raw material powder for the positive electrode margin 95a and the negative electrode margin 95b is synthesized. For example, it is possible to synthesize the raw material powder for the margin, by mixing raw material and additives and using solid phase synthesis method or the like. By dry-pulverizing the obtained raw material powder, it is possible to adjust the obtained material powder to a desired average particle size. For example, the particles are adjusted to a desired average particle size using a planetary ball mill using ZrO₂ balls of 5 mm diameter.

(Preparation process of electrode paste) Next, positive electrode pastes for making the positive electrode 10 and the negative electrode 20 described above are separately made. For example, the positive electrode paste and the negative electrodes paste can be obtained by uniformly dispersing a conductive aid, an electrode active material, a solid electrolyte material, a sintering assistant, a binder, a plasticizer, and the like in water or an organic solvent. The above-mentioned solid electrolyte paste may be used as the solid electrolyte material. A carbon material or the like may be used as the conductive aid. A metal may be used as the conductive aid. An example of the metal of the conductive aid is such as Pd, Ni, Cu, Fe, or alloys containing these. Pd, Ni, Cu, Fe, alloys containing these, and various carbon materials may also be used.

The sintering assistant of the positive electrode paste and the negative electrodes paste includes one or more of glass components such as Li—B—O-based compound, Li—Si—O-based compound, Li—C—O-based compound, Li—S—O-based compound and Li—P—O-based compound.

(Preparation process of external electrode paste) Next, an external electrode paste for manufacturing a first external electrode 40a and a second external electrode 40b described above is made. For example, a paste for external electrodes can be obtained by uniformly dispersing a conductive material, glass frit, binder, plasticizer and so on in water or an organic solvent.

(Preparation process of green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

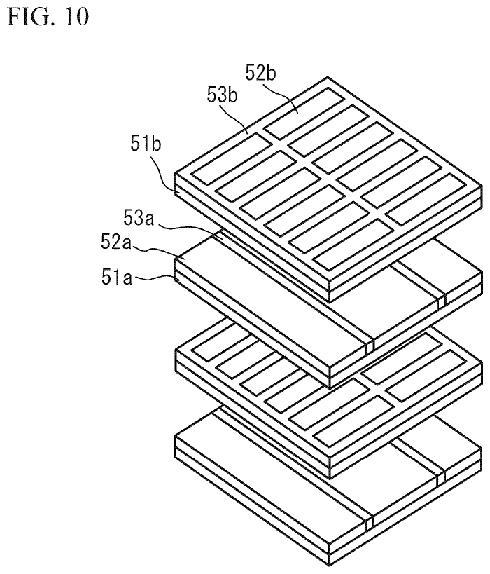

(Stacking and Cutting Process) As illustrated in FIG. 10, the positive electrode paste is printed on one side of a first solid electrolyte green sheet 51a, forming multiple band-shaped positive electrode patterns 52a. A positive electrode margin paste 53a is printed on the first solid electrolyte green sheet 51a in the gaps between the positive electrode patterns 52a. The positive electrode margin paste 53a can be formed by applying a margin raw material powder using a method similar to preparation process of the solid electrolyte green sheet. A negative electrode pattern 52b and a negative electrode margin paste 53b are printed on one side of a second solid electrolyte green sheet 51b. For example, the negative electrode margin paste 53b is printed on the second solid electrolyte green sheet 51b in the gaps between the negative electrode patterns 52b. The negative electrode margin paste 53b can be formed by applying a margin raw material powder using a method similar to the preparation process of the solid electrolyte green sheet.

As illustrated in FIG. 10, the first solid electrolyte green sheets 51a after printing and the second solid electrolyte green sheets 51b after printing are alternately stacked so that the positive electrode margin paste 53a and the negative electrode margin paste 53b are alternately offset. Cover sheets are pressed from above and below in the stacking direction to obtain a multilayer body.

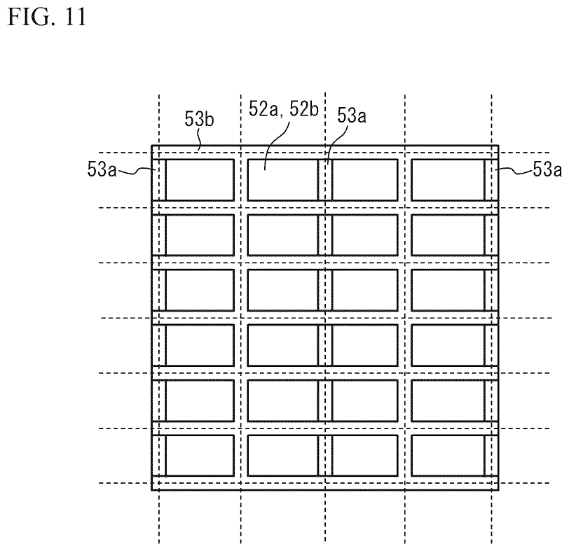

Next, as illustrated in FIG. 11, the multilayer body is cut from the Z-axis along cut lines that run along the X-axis and Y-axis directions to obtain a multilayer body of the multilayer chip 60 before firing. This multilayer body may be polished by barrel polishing or other methods. Polishing reduces contact between electrodes, preventing short circuits.

(Firing Process) Next, the resulting green chip is fired to obtain the multilayer chip 60. Firing conditions include, but are not limited to, an oxidizing or non-oxidizing atmosphere, with a maximum temperature of preferably 400° C. to 1000° C., more preferably 500° C. to 900° C. A step of maintaining a temperature lower than the maximum temperature in an oxidizing atmosphere may be added to thoroughly remove the binder before reaching the maximum temperature. To reduce process costs, firing at as low a temperature as possible is desirable. A re-oxidation process may be performed after firing.

(External Electrode Formation Step) Next, the external electrode paste is applied to two end surfaces of the multilayer chip 60 and cured to form the first external electrode 41 and the second external electrode 42, thereby obtaining the all solid battery 100a.

Alternatively, a first external electrode paste and a second external electrode paste may be applied to two end surfaces of the green chip obtained in the stacking and cutting process, followed by firing, to form the first external electrode 41 from the first external electrode paste and the second external electrode 42 from the second external electrode paste, thereby obtaining the all solid battery 100a.

### EXAMPLES

(Example 1) A stack type all solid battery was fabricated according to the above-described embodiment. The positive electrode active material 11 was LiCo_{0.7}Ni_{0.3}PO₄, which has an average discharge potential of 4.8 V vs. Li⁺/Li. The negative electrodes active material 21 was TiTa_{1.5}Nb_{0.5}O₇, which has an average discharge potential of approximately 1.5 V vs. Li⁺/Li. The solid electrolytes 12 and 22 were Li₁₊ₓAlₓGe₂₋ₓP₃O₁₂ (0<x<1) with a NASICON structure. As illustrated in FIG. 10, a multilayer body was formed by alternately stacking the first solid electrolyte green sheets 51a coated with the positive electrode pattern 52a and the positive electrode margin paste 53a and the second solid electrolyte green sheets 51b coated with the negative electrode pattern 52b and the negative electrode margin paste 53b. Cover sheets were then attached to the top and bottom of the multilayer body. After pressure molding, the multilayer body was cut along the cut lines illustrated in FIG. 11 to obtain individual chips. The individual chips were then degreased and fired, yielding 48 all solid battery chips having the electrode stacking structure illustrated in FIG. 8. The solid electrolyte contained in the positive electrode margin paste 53a and the negative electrode margin paste 53b was the same as the solid electrolyte contained in the first solid electrolyte green sheet 51a and the second solid electrolyte green sheet 51b.

No cracks or other defects were observed in any of the fired chips. It is thought that stress during firing was suppressed. This is thought to be because the contact interface between the electrodes and the margins was reduced by not providing the positive electrode margin 95a on the edge of the positive electrode 10 on the first side surface S1 side or the edge on the second side surface S2 side.

Furthermore, external electrodes were formed as illustrated in FIG. 7, and the chips were dried in dry air at 70° C. A charge/discharge test was performed, and no failures occurred during the initial charge in any of the chips. Therefore, stress during charge/discharge is thought to have been suppressed. This is also thought to be because the contact interface between the electrodes and the margins was reduced by not providing the positive electrode margin 95a on the edge of the positive electrode 10 on the first side surface S1 side or the edge on the second side surface S2 side. Furthermore, the provision of the negative electrode margin 95b on the edge of the negative electrode 20 on the first side surface S1 side or the edge on the second side surface S2 side reduced the drying defect rate and suppressed deterioration of electrical characteristics. The charge/discharge test was performed by soldering the chip to a land pattern substrate and sealing it in an exterior case.

The results are shown in Table 1. If no cracks occurred during firing, the “stress during firing” was judged as acceptable (o), and if no cracks occurred during charging and discharging, the “charge and discharge stress” was judged as acceptable (o). Additionally, if no failure occurred during the first charge during charging and discharging, the drying defect rate was judged as acceptable (o).

TABLE 1

| | | | NEGATIVE | |
|---|---|---|---|---|
| | | | ELECTRODE | |
| | | STRESS | AVERAGE | DRYING |
| | STRESS | DURING | OPERATING | DEFECT |
| | DURING | CHARGE/ | POTENTIAL | RATE |
| | FIRING | DISCHARGE | (vs. Li⁺/Li) | (%) |
| EXAMPLE 1 | ∘ | ∘ | 1.5 V | 0 |
| EXAMPLE 2 | ∘ | ∘ | 1.6 V | 0 |
| EXAMPLE 3 | ∘ | ∘ | 2.4 V | 0 |
| COMPARA- | x | x | 1.5 V | 0 |
| TIVE | | | | |
| EXAMPLE 1 | | | | |
| COMPARA- | ∘ | ∘ | 1.5 V | 6 |
| TIVE | | | | |
| EXAMPLE 2 | | | | |
| COMPARA- | ∘ | ∘ | 1.5 V | 6 |
| TIVE | | | | |
| EXAMPLE 3 | | | | |

(Example 2) A stack type all solid battery was fabricated according to the above embodiment. The same positive electrode active material and the same solid electrolyte as in Example 1 were used, and Al_{0.9}Hf_{0.1}Nb₉Ta₂O₂₉, with an average discharge potential of approximately 1.6 V vs. Li⁺/Li, was used for the negative electrodes active material. As illustrated in FIG. 10, the first solid electrolyte green sheet 51a coated with the positive electrode pattern 52a and the positive electrode margin paste 53a was alternately stacked with the second solid electrolyte green sheet 51b coated with the negative electrode pattern 52b and the negative electrode margin paste 53b to form a multilayer body. Cover sheets were then attached to the top and bottom. After pressure molding, the multilayer body was cut along the cut lines illustrated in FIG. 11 to obtain individual chips. The individual chips were then degreased and fired to obtain 48 all solid battery chips with the electrode stack structure illustrated in FIG. 8. The solid electrolyte contained in the positive electrode margin paste 53a and the negative electrode margin paste 53b was the same as the solid electrolyte contained in the first solid electrolyte green sheet 51a and the second solid electrolyte green sheet 51b.

No cracks or other defects were observed in any of the chips after firing. Therefore, it is thought that stress during firing was suppressed. This is believed to be because the positive electrode margin 95a was not provided on the edge of the positive electrode 10 on the first side surface S1 side or the edge on the second side surface S2 side, thereby reducing the contact interface between the electrode and the margin.

Furthermore, external electrodes were formed as illustrated in FIG. 7, and the chips were dried in dry air at 70° C. A charge/discharge test was performed, and no failures occurred during the initial charge in any of the chips. Therefore, it is thought that stress during charge/discharge was also suppressed. This is also thought to be due to the fact that the positive electrode margin 95a was not provided on the edge of the positive electrode 10 on the first side surface S1 side or the edge on the second side S2 surface side, thereby reducing the contact interface between the electrode and the margin. Furthermore, the negative electrode margin 95b was provided on the edge of the negative electrode 20 on the first side surface S1 side or the edge on the second side surface S2 side, thereby suppressing moisture adhesion and reducing degradation of electrical characteristics. Note that charge/discharge tests were performed by soldering the chip to a land pattern substrate and sealing it in an exterior case.

(Example 3) A stack type all solid battery was fabricated according to the above embodiment. The same positive electrode active material 11 and the same solid electrolytes 12 and 22 as in Example 1 were used, and the negative electrodes active material 21 was Li₁₊ₓAlₓTi₂₋ₓP₃O₁₂ (0≤x<1) with a NASICON structure and an average discharge potential of approximately 2.4 V vs. Li⁺/Li. As illustrated in FIG. 10, a multilayer body was formed by alternately stacking the first solid electrolyte green sheets 51a coated with the positive electrode pattern 52a and the positive electrode margin paste 53a and the second solid electrolyte green sheets 51b coated with the negative electrode pattern 52b and the negative electrode margin paste 53b. Cover sheets were then attached to the top and bottom of the multilayer body. After pressure molding, the multilayer body was cut along the cut lines illustrated in FIG. 11 to form individual chips. The individual chips were then degreased and fired, obtaining 48 all solid battery chips with the electrode stacking structure illustrated in FIG. 8. The solid electrolyte contained in the positive electrode margin paste 53a and the negative electrode margin paste 53b was the same as the solid electrolyte contained in the first solid electrolyte green sheets 51a and the second solid electrolyte green sheets 51b.

No cracks or other defects were observed in any of the fired chips. It is thought that stress during firing was suppressed. This is thought to be because the positive electrode margin 95a was not provided on the edge of the positive electrode 10 on the first side surface S1 side and the edge on the second side surface S2 side, thereby reducing the contact interface between the electrode and the margin.

Furthermore, external electrodes were formed as illustrated in FIG. 7, and the chips were dried in dry air at 70° C. A charge-discharge test was performed, and no failures occurred during the initial charge in any of the chips. Therefore, stress during charge and discharge is believed to have been suppressed. This is also believed to be due to the fact that the positive electrode margin 95a was not provided on the edge of the positive electrode 10 on the first side surface S1 side or the edge on the second side surface S2 side, thereby reducing the contact interface between the electrode and the margin. Furthermore, the negative electrode margin 95b was provided on the edge of the negative electrode 20 on the first side surface S1 side or the edge on the second side surface S2 side, thereby suppressing moisture adhesion and reducing degradation of electrical characteristics. The charge-discharge test was performed by soldering the chip to a land pattern substrate and sealing it in an exterior case.

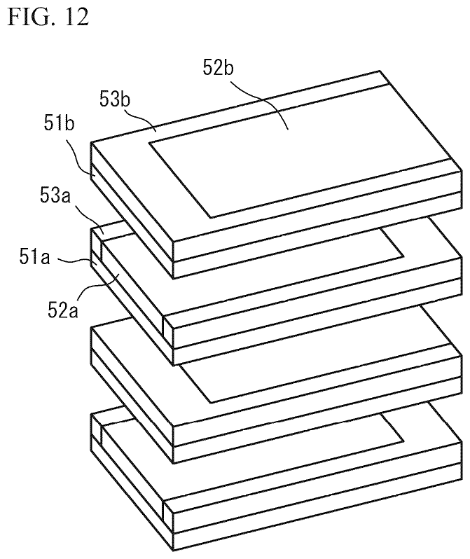

(Comparative Example 1) The same positive electrode active material 11, the negative electrodes active material 21, and the solid electrolytes 12 and 22 as in Example 1 were used. The first solid electrolyte green sheets 51a coated with the positive electrode pattern 52a and the positive electrode margin paste 53a and the second solid electrolyte green sheets 51b coated with the negative electrode pattern 52b and the negative electrode margin paste 53b were alternately stacked to form a multilayer body. Cover layers were then provided on the top and bottom of the multilayer body, which were then pressure-molded and cut into chips having the multilayer body illustrated in FIG. 12. These chips were then degreased and fired to obtain 48 all solid battery chips. Therefore, in Comparative Example 1, after firing, neither the positive electrode 10 nor the negative electrode 20 extended to the first side surface S1 nor the second side surface S2, and both the positive electrode 10 and the negative electrode 20 were covered with margins on the first side surface S1 and the second side surface S2.

In Comparative Example 1, visually noticeable cracks were observed in 6 of the 48 chips. This is thought to be because the margins on the edges of both the positive electrode 10 and the negative electrode 20, facing the first side surface S1 and the second side surface S2, increased the area of contact interfaces between the electrode and the margin, thereby increasing internal stress. Therefore, the stress during firing was judged as unacceptable (x).

Forty-two chips that were free of cracks were formed with external electrodes and dried in dry air at 70° C. A charge-discharge test was performed, and soft short circuit failures were confirmed during the initial charge in 10 chips. This is thought to be because the margins on the edges of both the positive electrode 10 and the negative electrode 20, facing the first side surface S1 and the second side surface S2, increased the area of contact interfaces between the electrode and the margin, causing internal microcracks to grow due to volumetric changes in the electrodes during charging, resulting in misalignment of the multilayer structure. Therefore, the stress during charge-discharge was judged as unacceptable (x).

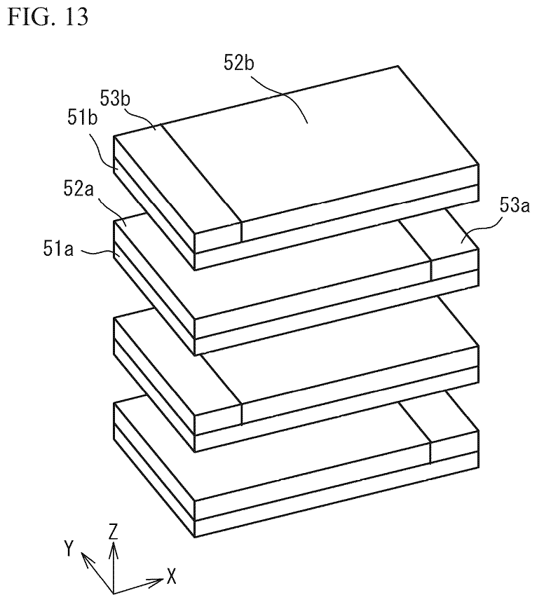

(Comparative Example 2) The same positive electrode active material 11, the negative electrodes active material 21, and the solid electrolytes 12 and 22 as in Example 1 were used. The first solid electrolyte green sheet 51a coated with the positive electrode pattern 52a and the positive electrode margin paste 53a and the second solid electrolyte green sheet 51b coated with the negative electrode pattern 52b and the negative electrode margin paste 53b were alternately stacked to form a multilayer body. Cover layers were then applied to the top and bottom of the multilayer body, and the multilayer body was cut after pressure molding. The resulting chips had the multilayer structure illustrated in FIG. 13. These were then degreased and fired to obtain 48 all solid battery chips. Therefore, in Comparative Example 2, both the positive electrode 10 and the negative electrode 20 were extended to the first and second side surfaces.

In Comparative Example 2, no cracks or other defects were observed in any of the chips after firing. This is thought to be because the positive electrode 10 and the negative electrode 20 were not covered by margins on the first side surface S1 and the second side surface S2, reducing the contact interface between the electrode and the margin and reducing internal stress.

External electrodes were then formed, and the chips were dried in dry air at 70° C. A charge/discharge test was performed, and 45 chips operated without failure. However, three chips exhibited poor drying, with a Coulomb efficiency of 70% or less during the initial charge/discharge (drying failure rate=3/45×100%=6%). This is thought to be because the negative electrodes, which has a lower average operating potential than the positive electrode, extended to the first and second side surfaces, causing a side reaction between the negative electrodes and attached moisture during charge/discharge operations.

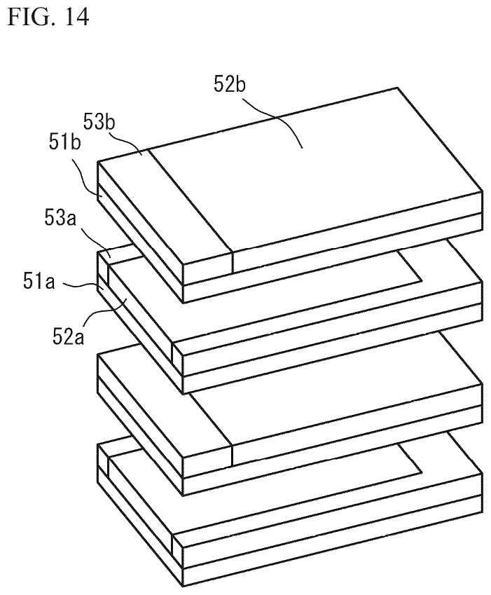

(Comparative Example 3) The same positive electrode active material 11, the negative electrodes active material 21, and the solid electrolytes 12 and 22 as in Example 1 were used. The first solid electrolyte green sheet 51a coated with the positive electrode pattern 52a and the positive electrode margin paste 53a and the second solid electrolyte green sheet 51b coated with the negative electrode pattern 52b and the negative electrode margin paste 53b were alternately stacked to form a multilayer body. Cover layers were then applied to the top and bottom of the multilayer body, and the multilayer body was pressure-molded and cut. The resulting chips had the multilayer structure illustrated in FIG. 14. These were then degreased and fired, obtaining 48 all solid battery chips. Therefore, in Comparative Example 3, the positive electrode 10 was not extended to the first side surface S1 and the second side surface S2, but was extended to the first side surface S1 and the second side surface S2. The positive electrodes 10 was covered with margins on the first side surface S1 and the second side surface S2.

In Comparative Example 3, no cracks or other defects were observed in any of the chips after firing. This is thought to be because the edges of the negative electrode 20 on the first side surface S1 side and the second side surface S2 side were not covered with margins, reducing the contact interface between the electrode and the margin and reducing internal stress.

External electrodes were then formed, and the chips were dried in dry air at 70° C. A charge/discharge test was performed, and 45 chips operated without failure. However, three chips exhibited poor drying, with coulombic efficiency of 70% or less during the initial charge/discharge (drying failure rate=3/45×100%=6%). This is thought to be because the negative electrodes, which has a lower average operating potential than the positive electrode, extended to the first and second surfaces, causing a side reaction between the negative electrodes and attached moisture during charge/discharge operations.

(Battery Energy Density) Next, the battery voltage was measured for the all solid state battery chips of Examples 1 to 3 and Comparative Examples 1 to 3. The battery voltage was 3.2 V for Example 1, 3.1 V for Example 2, 2.3 V for Example 3, and 3.2 V for Comparative Examples 1 to 3. Thus, the battery voltage and energy density were higher in Examples 1 and 2 than in Example 3. This is because the average operating potential of the negative electrodes active material in Examples 1 and 2 was less than 2 V vs. Li/Lit.

Although the embodiments of the present invention have been described in detail, it is to be understood that the various change, substitutions, and alterations could be made hereto without departing from the spirit and scope of the invention.

What is claimed is:

1. An all solid battery comprising:
a first electrode layer including a first electrode that includes a first electrode active material and that is quadrilateral in plan view, and a first margin that is quadrilateral in plan view, the first electrode layer being formed by connecting the first electrode and the first margin;
a second electrode layer including a second electrode that has a quadrilateral shape in plan view and that includes a second electrode active material that has a lower average operating potential than the first electrode active material, and a second margin that is connected to one side of the quadrilateral shape of the second electrode, the quadrilateral shape having a first side and a second side that are adjacent to the one side, the second margin extending to the first side; and
a solid electrolyte layer arranged between the first electrode layer and the second electrode layer.

2. The all solid battery as claimed in claim 1,
wherein the second margin extends so as to be in contact with an entire of the first side and an entire of the second side of the second electrode.

3. The all solid battery as claimed in claim 2,
wherein in plan view, the solid electrolyte layer is a quadrilateral, and the quadrilateral of the solid electrolyte layer and the quadrilateral of the first electrode layer are substantially coincide with each other.

4. The all solid battery as claimed in claim 1,
wherein the second margin has a width of 50 μm or more and 1000 μm or less toward the first side in plan view of the second electrode layer in a region connected to the first side of the second electrode.

5. The all solid battery as claimed in claim 1,
wherein the second margin contains a same solid electrolyte component as the solid electrolyte layer.

6. The all solid battery as claimed in claim 2,
wherein the second margin contains a same solid electrolyte component as the solid electrolyte layer.

7. The all solid battery as claimed in claim 1,
wherein the solid electrolyte contained in the solid electrolyte layer is an oxide-based solid electrolyte.

8. The all solid battery as claimed in claim 2,
wherein the solid electrolyte contained in the solid electrolyte layer is an oxide-based solid electrolyte.

9. The all solid battery as claimed in claim 1,
wherein an average operating potential of the second electrode active material is less than 2 V vs. Li/Li⁺.

10. The all solid battery as claimed in claim 2,
wherein an average operating potential of the second electrode active material is less than 2 V vs. Li/Li⁺.

11. The all solid battery as claimed in claim 1 further comprising:
a first terminal that is in contact with the first electrode, the solid electrolyte layer, and the second margin; and
a second terminal that is in contact with the second electrode, the solid electrolyte layer, and the first margin.

12. The all solid battery as claimed in claim 2 further comprising:
a first terminal that is in contact with the first electrode, the solid electrolyte layer, and the second margin; and
a second terminal that is in contact with the second electrode, the solid electrolyte layer, and the first margin.

13. An all solid battery comprising:
a first electrode layer including a first electrode that includes a first electrode active material and that is quadrilateral in plan view, and a first margin that is quadrilateral in plan view, the first electrode layer being formed by connecting the first electrode and the first margin, the first electrode active material capable of absorbing and releasing lithium ions, the first electrode active material being an oxide containing lithium and including at least one element selected from a group consisting of titanium, vanadium, manganese, iron, cobalt, nickel, phosphorus, and silicon;
a second electrode layer including a second electrode that has a quadrilateral shape in plan view and that includes a second electrode active material that has a lower average operating potential than the first electrode active material, and a second margin that is connected to one side of the quadrilateral shape of the second electrode, the quadrilateral shape having a first side and a second side that are adjacent to the one side, the second margin extending to the first side, a second electrode active material capable of absorbing and releasing lithium ions, the second electrode active material being any one of an oxide, a conductive carbon material, an elemental metal, or an alloy containing at least one element selected from a group consisting of lithium, titanium, niobium, tantalum, and hafnium; and
a solid electrolyte layer arranged between the first electrode layer and the second electrode layer.

14. The all solid battery as claimed in claim 13,
wherein the second margin extends so as to be in contact with an entire of the first side and an entire of the second side of the second electrode.

15. The all solid battery as claimed in claim 14,
wherein in plan view, the solid electrolyte layer is a quadrilateral, and the quadrilateral of the solid electrolyte layer and the quadrilateral of the first electrode layer are substantially coincide with each other.

16. The all solid battery as claimed in claim 13,
wherein the second margin has a width of 50 μm or more and 1000 μm or less toward the first side in plan view of the second electrode layer in a region connected to the first side of the second electrode.

17. The all solid battery as claimed in claim 13,
wherein the second margin contains a same solid electrolyte component as the solid electrolyte layer.

18. The all solid battery as claimed in claim 13,
wherein the solid electrolyte contained in the solid electrolyte layer is an oxide-based solid electrolyte.

19. The all solid battery as claimed in claim 13,
wherein an average operating potential of the second electrode active material is less than 2 V vs. Li/Li⁺.

20. The all solid battery as claimed in claim 13 further comprising:
a first terminal that is in contact with the first electrode, the solid electrolyte layer, and the second margin; and
a second terminal that is in contact with the second electrode, the solid electrolyte layer, and the first margin.
